(19) United States
(12) Patent Application Publication
(10) Pub. No.: US 2011/0171980 A1
(43) Pub. Date: Jul. 14, 2011

(54) METHOD AND SYSTEM FOR ADVERTISING IN A MOBILE HANDHELD DEVICE

(75) Inventors: Niklas SJöberg, Saltsjo-Boo (SE); Johan Frenckner, Stockholm (SE)

(73) Assignee: Mozoomi AB, Saltsjo-Boo (SE)

(21) Appl. No.: 12/685,751

(22) Filed: Jan. 12, 2010

(51) Int. Cl. G06Q 30/00; H04W 4/00; G06F 3/048

(52) U.S. Cl. 455/466; 705/14.64; 705/14.17; 715/764

(57) ABSTRACT

This invention relates to advertising in a mobile handheld devices with voice telephony capabilities by partly transferring the control over certain functions in the device, such as the selection of wallpaper, screensaver or gadgets, from the user to another party for example the phone network operator, advertisers and companies reselling advertising space, with a possible direct interaction with the billing system of the phone operator.

### FIELD OF THE INVENTION

The present invention relates generally to a solution for mobile marketing. More specifically the invention relates to advertising in a mobile handheld device with voice telephony capabilities (hereinafter referred to as “mobile communication device” or “MCD”) by partly transferring the control over certain functions in the device, such as the selection of wallpaper, screensaver or gadgets, from the user to another party for example the phone network operator, advertisers and companies reselling advertising space, with a possible direct interaction with the billing system of the phone operator.

### BACKGROUND OF THE INVENTION

According to several studies mobile marketing offers the best return on investment (“ROI”) compared to other marketing communication channels. Mobile marketing has greater targeting capabilities and more personalization possibilities. Sending relevant, tailored and timely messages to a consumer's mobile device delivers far higher conversion rates from communication to sales. The always-on, always-available nature of the mobile device presents a unique opportunity for marketers to engage directly with consumers, building a meaningful dialogue, while respecting consumer privacy.

Over the past 5 to 10 years several companies have developed various mobile communication platforms to enable marketing activities to mobile devices. The communication has often been based on SMS (short message service), MMS (multimedia messaging service) or WAP (wireless application protocol).

In spite of the huge potential in mobile marketing there are a number of problems with the current techniques. A mobile device is not an appropriate medium when it comes to initiating contact with a consumer. There are regulations forbidding spam that limit the possibility for advertisers to actively target new consumers through the mobile medium. Anyhow companies not respecting spam regulations are very common in many geographical regions.

The user friendliness, when it comes to Internet surfing with the mobile, is far behind the computer. When the Internet is used with the MCD, the purpose is rather to find specific information than surfing around for new and interesting sites. Mobile marketing campaigns require active behavior from the user, for example the opening of an SMS or MMS or the visit on an online site. This means that most users are never exposed to such an ad. Mobile marketing campaigns can be a disturbing factor to the user and interfere with what the user wants to use the mobile device for. All in all, mobile marketing campaigns have so far been designed to suit the purpose of advertisers rather than achieving acceptance from the mobile users.

Companies have handled the abovementioned problems in different ways. In order to reach the users, mobile marketing campaigns are often combined with other media. For example, the user can be encouraged via other media to send an SMS with a short code in order to receive further information in the mobile device. This often leads to relatively complex and costly campaigns, with low predictability of the ROI.

The various embodiments of the invention discussed below and elsewhere herein provide solutions to these and other problems. It should be expressly understood that although reference is hereafter made to many features of the invention, both by way of description and explanation, and in comparison to that which has been done in the past, it is not necessary that all features be used in any single embodiment nor is the invention limited to the precise embodiments described hereafter. The scope and breadth of the invention is to be limited only by the claims, and includes within its scope all equivalents thereof.

Consumer behavior typically is measured in terms of how the consumer acts in relation to the ad, for example, the number of clicks on a link and not by how the consumer uses the mobile device. The invention presented herein not only measures how consumers react to an ad but also how often they use the mobile device even if this usage is not at all related to the ad. Such information is most useful in planning future marketing campaigns.

By the system of the invention herein enabling advertisement in the mobile device and transferring some of the control over specific functions in the device to another party for example the phone network operator, advertisers and companies reselling advertising space, with a possible direct interaction with the billing system of the phone operator, the abovementioned problems are solved. The advertisement can be placed, for example, as wallpaper or screensaver and/or as a gadget. The ad could of course include interactive features but even if the consumer is completely passive he or she will be exposed to it. By measuring how the consumer uses the mobile device it is possible to measure how he or she is exposed to a specific ad even if the ad does not lead to any change in the consumer behavior. Through the direct contact with the network operator's billing system the cost for the user of the mobile device may be influenced.

Others have attempted to work in the fields of mobile telephony displays and/or interactive advertising, but without the success of the present invention. Examples of such attempts are discussed below.

US 2007/0195105 A1 describes certain dynamic wallpapers and how the content of the wallpaper can be updated by others than the user of the MCD. It discloses certain factors that could trigger the update of content. But this patent application does not address advertising content and the connection to the network operators billing system, thus, the invention does not include technical features for supporting such purposes. More specifically, the invention does not cover a technical solution how users could be compensated for accepting the content, nor do the logics behind the content update cover any optimization features with regards to the wallpaper as an advertising space. Furthermore, the update of content is fully reliant on a regular client-server communication. This could lead to a number of problems, for example, when it comes to the cost for data traffic, the limited battery capacity of the mobile device and the impact of other functions in the mobile device. Finally, the technology does not enable interactivity in the sense that the user can engage with the content presented in the display.

The invention described herein has solved the problems by combining a client-server communication system for updating wallpapers with a logical structure for how to display content based on a number of specific parameters, a reporting system based on how the user is exposed to the content and billing integration towards network operators, meaning a new technical and commercial usage is enabled by this invention. Our invention enables users of mobile devices to be rewarded by selling media space such as the wallpaper and/or the screen saver. This opens up for new pricing structures and subscriptions models in the telecom industry. Our invention has also solved the potential problems with the client-server communication as described in US 2007/0195105 A1 by separating the delivery of the content to the MCD from the display of the content in the MCD, as described below. In our invention, the content, as well as the logical structure for displaying it, preferably are transferred to the client only on specific occasions after pre-checking the mode of the mobile device, and the update of content will not negatively affect the user experience. The invention herein also includes another component, a so-called gadget, which is described below, that is synchronized with the application displaying the content in a way that interactivity is enabled.

Both WO 08080021 and US 2009/0198580 A1 describe methods and systems for enabling interactive advertising with an MCD. They include a whole system for displaying content in a mobile device in a way that enables the user to interact with the content via a user interface, systems for delivering content to the mobile device and for managing the advertising campaigns. The system includes a tracking system that serves as a basis for invoicing advertisers. The delivery of content to the device can take place in another point in time than it is displayed. Thus, the dependence on server connection has been somewhat reduced. Some specified events determine which content item should be displayed, possibly interactivity, and there is a system to check some parameters corresponding to the exposure of advertisements.

There are a number of limitations and shortcomings of those solutions that can be expected to substantially limit the number of potential users being technically able to, or willing to, opt-in for the advertising. Also the number of potential advertisers may be limited due to different factors, mentioned below.

The system described in WO 08080021 is a major compromise on the user friendliness of the mobile device due to the fact that it affects the navigation on the device. This application on the MCD is based on pop-up functionality meaning that the user must click on a button in order to disrupt the ad and be able to use the MCD. Even though the application might temporarily be able to run transparently in the background without a UI the purpose is to enable a server connection and a user interface and, in turn, enable interaction with the user. Furthermore, not only does the user need to click away the display of advertising content when he or she uses the device, but also the user might be interrupted when actually using the device. Events that could trigger the application to display content are not well defined and could occur and trigger content to be displayed even though other content is already displayed. If the user does not interact with the ads, no rewards will be given. The system in US 2009/198580 has also a negative impact on the user experience, although the ad content is intended to be displayed during certain waiting sessions. However, in both abovementioned systems the application in the client unit enables interactivity by assigning a handset soft key programmed to, for example, activate a link to an online site. This affects the navigation on the device. Moreover, it puts restrictions on the number of devices that are compatible with those solutions.

The advertisements, using the solutions above, are also likely to have a significant negative impact on the battery consumption of the mobile device. However, the battery consumption is hard to predict and might vary substantially between users and time periods. To some extent the solution in WO 08080021 takes into account the problem of battery consumption, but rather than finding ways to limit the battery consumption it avoids communication when the battery strength is low. Also the advertisements are likely to lead to significant data transfers between the mobile device and the server. In the system described in WO 08080021 it is said that content that is not time critical is transferred when the network bandwidth is cost effective. However, due to the very regular server connections and time critical content, a large amount of data will inevitably be transferred.

The user will have limited control over the amount of data that is transferred. Also, the possibility for the user to interact with content without logging in, means a high risk of unintentional data transfers. In the system described in US 2009/0198580 A1 much data may also be transferred since it includes video content. Neither of the solutions includes a blocking mechanism for ensuring that data is not transferred if it triggers roaming charges between network carriers, which can be extremely costly to the end user.

Further, neither of the systems includes the possibility for the end user to temporarily control the content displayed. Either the application is installed and the user gives up parts of the control over the device or the application has to be uninstalled.

Also the offers to users to use the systems above are permission based without a technical solution defining how the user is directly rewarded. In the system described in WO 08080021 the intended indirect reward consists of well targeted advertising offers that could be of interest to the user. Even if the possibility to offer inducements to users is mentioned in a parenthesis it is clearly not the purpose of the invention, since neither the method nor the system has technical support for offering monetary direct rewards to users as the system is not integrated with the network carriers' billing systems. Thus, the users cannot be automatically compensated for opting in to the service. Secondly, the display of content is only partly controlled by the user, which means that the inducement would need to be different for each user. What can be reported is primarily how much the user interacts with the content, which is therefore the only basis for determining the level of inducement. The system described in US 2009/0198580 A1 mentions the possibility to offer the user discounted content or free content if the user has the application installed. However, none of the solutions above includes a system for reducing the user's cost for the mobile communication such as reduced bills, including a technical solution for new subscription models to be offered by the network carriers. All in all, due to the large impact on the usage of the MCD as well as the limited technical solution for user inducements, the system described in WO 08080021 can only attract a fraction of the total number of users of MCDs. Due to the fact that users are indirectly rewarded in terms of different offers, the system is not applicable for many other types of advertisement, such as when building brand awareness. These factors, in turn, have an impact on the number of advertisers for which the service is relevant. Further regarding the system described in US 2009/0198580 A1 the ads will not be displayed very often since it is limited to the event when the user is downloading or uploading other kinds of content.

The methods and system of the invention described herein fulfils a different purpose than the abovementioned solutions. Firstly, the service that is enabled by our invention is targeted to another user segment which can be expected to be several times larger since the user only has to accept passive advertisements in the wallpaper of the mobile device which does not affect the navigation or other normal use of the device. Secondly, it gives a technical solution to possibly reduce the user's cost for mobile communication. Thus, compared to systems enabled by prior art, the end user may give up less and receive a lot more based on the service that is enabled by the technology from our invention.

The method and system presented in the disclosure herein contains a number of new technical features. These are focused on avoiding negative impacts on the user friendliness/experience as well as maximizing the value of the advertising space in order to give advertisers high return on investments and enable substantial rewards to users.

A benefit of the inventive technology is that it is based on the standard structure for how to display content in an MCD. The application that displays the content in the background of the MCD is installed as wallpaper and/or screen saver and the interactivity is enabled using the standard gadget framework. The application in the present invention is not based on a pop-up functionality and does not need to assign any soft key on the MCD in order to enable interactivity. This means that the present invention does not interfere with the existing navigation system of the MCD and, thus, does not reduce the end user experience. Moreover, based on its technical stand-alone design, the application will be compatible with a larger number of MCDs than many prior commercial applications, thus increasing the number of users that can take advantage of the service and, in turn, the number of advertisers being attracted by the media.

Another benefit of installing the application as wallpaper and/or screen saver as well as enabling interactivity by installing a gadget specifically used for this purpose based on a standard gadget framework is the optimized micro process for running the application. Furthermore, most of the intelligence of the system can be placed on the server-side. This minimizes the process capacity need and, in turn, the battery consumption.

Since the display of content in our invention is predictable, also the effect on battery consumption is relatively stable and predictable. This means that the risk that the end user is negatively affected in terms of battery strength is substantially lowered.

Further as the application in our invention is focused on passive advertisement displayed as wallpaper and/or screen savers, and interactivity is enabled by using a gadget based on a standard gadget framework, the need for server communication is very limited. The occasions when the application communicates with the server can also be fully predetermined. This means that the amount of data that is transferred can be low and predictable. The invention herein also includes features that can ensure that data is not transferred at high costs by postponing the data transfer if there are roaming charges.

By automatically changing content every time the application turns to an active mode, new ads may constantly be displayed. This will ensure that the user does not stop paying attention to the advertisement and will increase the value of the wallpaper and/or the screen saver as an advertising space.

The technical solution of the invention makes it possible to reward the user in different ways including a fixed amount per time unit credited to the user's account for mobile communication. This means also that the security issues are important when it comes to ensuring that the application is running properly. If the user would uninstall the application a message is sent to a server and the user is informed that the service agreement is terminated. If the wallpaper, due to manipulation by the user, is not displayed although the application is running actively, this may be registered and a message to the server is sent. This could in turn affect the discount to the user, the billing towards the advertiser or that the service agreement is terminated.

If the value of the advertising space temporarily is higher to the user than to the advertiser, potentially because there are no ads to be shown but also potentially for other reasons specific to the user, the application may become invisible and thereby enable the user to take control of the advertising space. Using this option, the user experience of the advertising space can be optimized.

Thus, it is an object of the invention herein to enable passive advertising that does not interfere with the usage of the mobile device or have a negative impact on the user experience. In summary, this invention permits advertisers to carry out marketing campaigns in mobile devices that do not rely on an active behavior from the end user. This invention also now makes it possible to automatically reward the user in monetary terms for accepting such advertisement.

As set forth herein, to effectively construct a method and a system for enabling passive advertising in mobile devices four demands should be fulfilled. First, it shall have no significant impact on how the user navigates on the mobile device even though interactivity with the ad may be enabled (meaning no additional clicks from a user are required due to the ad, for the user to interact normally with the mobile device as though the ad were not installed). Second, it shall not require any active behaviour from the end user. Three, the effect on battery consumption and the cost for data transfer should be limited, predictable and proportionate to the usage of the device. Four, it shall be possible to automatically compensate the end user, preferably with real money but alternatively with other rewards that have value to the user. The method and system of the invention herein fulfil these demands. None of the prior art known to the inventors, whether taken either singularly or in combination, describes the instant invention.

### SUMMARY OF THE INVENTION

The invention partly transfers the control of the selection of content in the wallpaper, screensaver, or gadgets of a mobile device from the end user to an advertiser, and also provides means to ensure that the consumer cannot control the selection of content under specific circumstances and that such potential infringement is noticed. By using a technology based on the existing technical structure and standards of the MCD, the invention is enabled on a large number of different MCDs.

Embodiments of the invention include a mobile marketing platform comprising means to provide advertising opportunities in an MCD that does not require active behavior from the user and that does not reduce the user experience, but still enabling user interaction with the advertisement without affecting the navigation system of the MCD.

Embodiments of the invention also include means to measure how often the user is exposed to the advertisement and, thus, to provide technical support for a business model where the price for the advertising space is dependent on the extent the user is exposed to the ads and to optimize the value of such advertising space by using a logical structure for how the ads shall be displayed. In return for transferring the control of the MCD's background the end user might be automatically rewarded by, for example, subsidizing the subscription, loading the prepaid card or by offering discounts on certain products or services.

Other objects and advantages of the present invention will become obvious to the reader and it is intended that all of these objects and advantages, including those, which become apparent from practicing the invention as claimed, are within the scope of the present invention.

### BRIEF DESCRIPTION OF THE DRAWINGS

FIG. 1 is an overview of the system architecture and functions.

FIG. 2 is a description of an over the air (“OTA”), or remotely provisioned, installation of the application.

FIG. 3 is a description of the client-server communication.

FIG. 4 illustrates the internal process in the application.

FIG. 5 describes how interactivity is enabled by a gadget.

FIG. 6 illustrates how an ad packaged is assembled.

FIG. 7 illustrates how an ad schedule is set.

### DETAILED DESCRIPTION OF THE INVENTION AND PREFERRED EMBODIMENTS THEREOF

### Introduction

The application and method presented in this invention may be used to satisfy the need for users of handheld mobile devices with voice telephony capabilities in order to reduce their mobile communication costs as well as the need for advertisers to provide highly targeted and cost effective advertising. The handheld device could be, but is not limited to, a cellular phone or a telephone enabled PDA, hereinafter referred to as a mobile communication device (MCD).

The method and the system enable advertisement to be shown in the background of a display on an MCD, hereinafter referred to as wallpaper and/or screen saver, as well as in the foreground as one or several clickable gadgets. The content displayed in the wallpaper is static and always displayed at the background, or “lowest level,” of the display. Thus, the advertisement made in the wallpaper on the mobile device may be fully passive and does not in any way change the way a user interacts with the mobile device. The same holds for advertisement displayed as screen savers. A gadget is a small stand-alone application running on the graphical user interface on, for example, an MCD. A gadget often has a limited size and may be displayed in a specific area of the MCD. A gadget generally has a specific purpose, for example, displaying time, weather or a calendar. It could also include a link to a URL. There are synonyms for gadgets, for example widgets and gizmos. All such applications are hereinafter referred to as gadgets. A gadget is triggered by a user of the device on which the gadget is displayed, for example an MCD. The user typically triggers (“clicks”) the gadget by clicking an active area of the gadget display indirectly with a mouse or directly with a finger or pen although other means of clicking can be used.

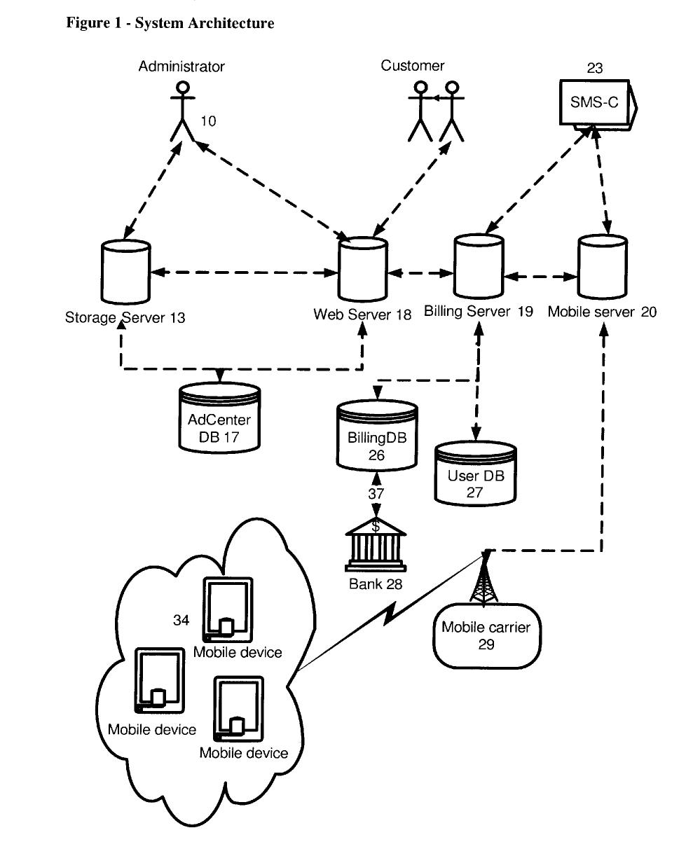

For gadget enabled mobile devices, which means that the device has the capability for displaying and showing gadgets, one or more gadgets may be added to the mobile device user interface (UI) and synchronized with the application that controls the display of advertisement in the wallpaper and/or screen saver. On these mobile devices the mobile user may engage with the advertisement by clicking one of the gadgets that is related to the wallpaper. At the same time the MCD may contain several different gadgets related to other advertisements controlled by the mobile server 20 in FIG. 1.

A benefit of the present invention is that it is based on the standard structure for how to display content in an MCD. The application that displays the content in the background of the MCD is installed as wallpaper and/or screen saver using the built in function of the mobile device. The gadget that may be related to the ad, enabling interactivity from the MCD, is built on the standard gadget framework or the standard gadget API (Application Programming Interface). This means that the application and the gadget in the present technology is not based on a pop-up functionality and does not have to assign any soft key on the MCD in order to enable interactivity. Thus, the present technology does not interfere with the existing navigation system of the MCD and, thus, does not reduce the end user experience.

Another benefit of using standard mobile API's and working in a client/server environment, meaning most of the heavy processing will be done on the server side to reduce the workload for the MCD, is the reduced battery consumption on the MCD. Since the client-server communication can be predetermined the effect on battery consumption due to server communication can be predictable. For example, the effect on battery consumption from the application will be proportionate to the usage of the device when the application is set up so that it is activated every time the user logs in or locks up the device. Thus, the effect from the service enabled by this invention on battery consumption is limited and predictable.

Since the only noticeable or significant impact on the MCD is the content displayed passively in the wallpaper and/or screen saver and the possibility to interact with the content in a standardized way, the present disclosure may be installed in a large number of different devices. Therefore, a large number of end users can take advantage of the system, which in turn fulfills advertisers' need to reach a large target group.

An additional feature of the inventive technology is the integration to a billing system. In contrast to the existing usage of the billing system, that is, charging end users for various services or purchases via the invoices of the network carriers, the system may be used the other way around. This means that end users can be automatically rewarded in monetary terms for accepting advertisement displayed as wallpaper or screen saver and/or as gadgets. An example of reward might be that on post-paid subscriptions the invoice could be reduced whereas end users with pre-paid cards could get the card loaded with a certain amount.

### System Architecture

With reference to FIG. 1, there is an overview of the ecosystem of an embodiment of the invention.

The mobile server 20 connects to the MCD though the mobile carrier 29 or any other communication network known at the time. The server park is made up by four different types of servers all playing a vital role to create the mobile advertisement ecosystem: mobile server 20, billing server 19, web server 18 and storage server 13. For simplicity, these servers and various databases are separately identified and are discussed and illustrated as though they each are separately housed but it will be apparent to the reader that one or more of the servers and/or databases can be combined and that separate devices are not required to perform their functions. The mobile server 20 controls the interaction with the MCD users, for example, when it comes to distributing the application and the gadget to the MCD, sending ad packages to the application and uploading usage data from the application. The mobile server 20 also forwards uploaded data to the other parts of the system, for example, in the illustrated embodiment, billing data is forwarded to the billing server 19 and usage data is forwarded to the storage server 13 as a basis for setting ad packages. The mobile server 20 receives ad packages from storage server 13 that interacts with ad center database 17. The billing server 19 processes the billing data based on, among other factors, payment model agreements with advertisers and the agreements with end users, and stores the data in the user database 27 and the billing database 26. The billing server 19 handles out rewards to end users by integrations with the billing system of network carriers and/or billing providers, through smart message center (“SMS-C”) 23. The bank 28, will handle all outgoing payments that cannot be carried out through the SMS-C 23. The billing server 19 is also internally integrated to a system that produces invoices to advertisers.

Advertisers can login to the system, which is handled by the web server 18. The web server interacts with the storage server 13 and the ad center database in order to receive and present relevant information to advertisers including, but not limited to, information about prices, available slots, target group demographics and campaign statistics. Advertisers may, for example, place orders, upload content and monitor campaign statistics. Placed orders are transferred to the billing server and uploaded content is automatically re-sized and optimized for different MCDs and stored in the ad center database 17. The ordering process and the uploaded content are to some extent controlled automatically and to some extent monitored by an administrator 10.

### Interface for Advertisers/Ad Center

Advertisers may be given the ability to design campaigns in a web interface. The design of a campaign may be made by setting certain target group criteria, including but not limited to:

Age interval

Gender

Address

Other demographics such as hobbies

Also other more specific criteria may be set for the campaign, including but not limited to:

Time criterion—certain points in time during which an ad should be displayed

Location criterion—location events that should trigger the exposure of an ad.

The advertiser also would typically set the calendar period for the campaign that is, how long the campaign will continue, the beginning date and/or the end date for the campaign.

After the campaign criteria and calendar period have been selected, the data is processed and a result is displayed. The result includes available slots, that is, the number of unique users for which the ad can be shown during the certain calendar period. The result also specifies the type of available slots (wallpapers, screensavers and/or gadgets).

The advertiser may be permitted to set criteria related to the size of the campaign, including but not limited to:
The maximum number of exposures for each ad specified per type of slot (wallpaper, screensavers and/or gadgets) according to budget restrictions
The minimum number of unique users that an ad should be exposed for
The minimum number of exposures for an ad
The maximum number of exposures for an ad.

The invention allows the payment model to be flexible. For wallpaper and screensaver ads the payment model may be CPM (cost per mille), that is, the cost for 1,000 exposures of a certain ad. For gadgets the payment model could also be based on the number of clicks or a certain action that is achieved after the user has clicked on the gadget. The advertiser may be given the ability to select the payment model to some extent.

Once all relevant data selections have been made, the data is processed and a result is displayed. The result includes the total cost for the campaign. The advertiser is offered to continue and book the campaign or make a new search by changing the search criteria.

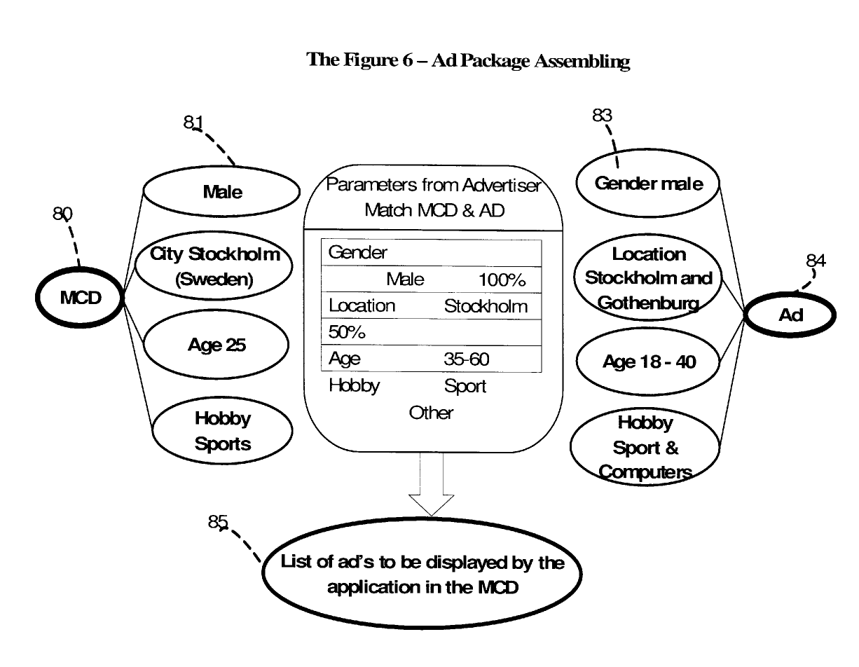

When a campaign has been designed each ad has been assigned specific parameters, whether those parameters have been selected by the advertiser as described above, or pre-assigned in whole or part, for example by the system owner. These parameters will be used when assembling the ad package as described in FIG. 6.

When booking a campaign, the advertiser receives a specific login. After having booked the campaign, the advertiser may be requested to upload material, such as pictures, logos or other material. If a gadget is included in the campaign the advertiser may also be offered to create a landing site for the gadget (a URL to which the gadget is connected) as well as setting the potential relation between the gadget and the wallpaper, meaning that the ad displayed in the wallpaper may have a relation to the URL in the gadget. Every time the ad in the wallpaper is changed, the URL in the gadget also changes and points to more online advertisement content associated to the ad displayed in the wallpaper at each point in time. Thus, when the gadget is triggered by the user the MCD will start up the mobile browser and display more advertisement content related to the ad currently displayed in the wallpaper.

When a campaign is active or completed the advertiser may be able to log in to the website and monitor the campaign result, for example, in terms of statistics over the number of exposures and/or clicks for each unique user. If the maximum number of exposures, set by the advertiser when designing the campaign, has not been fulfilled during the calendar period the advertiser may choose to prolong the time for the campaign. The advertiser may also be able to view the remaining amount of the total campaign budget.

### Installation of the MCD Client Application and the Gadget

The application and the optional gadget may be installed in several ways. In one embodiment, network carriers may pre-install the application and the gadget (if there is a gadget) on new mobile devices before they are sold to the users and/or may install the application and any gadget OTA to existing subscribers that have agreed to the service. The application and its gadget, if any, may also be pre-installed by either the equipment or mobile device manufacturer. Another alternative is that the application and the gadget is installed by the user or self-installed after being distributed to the user.

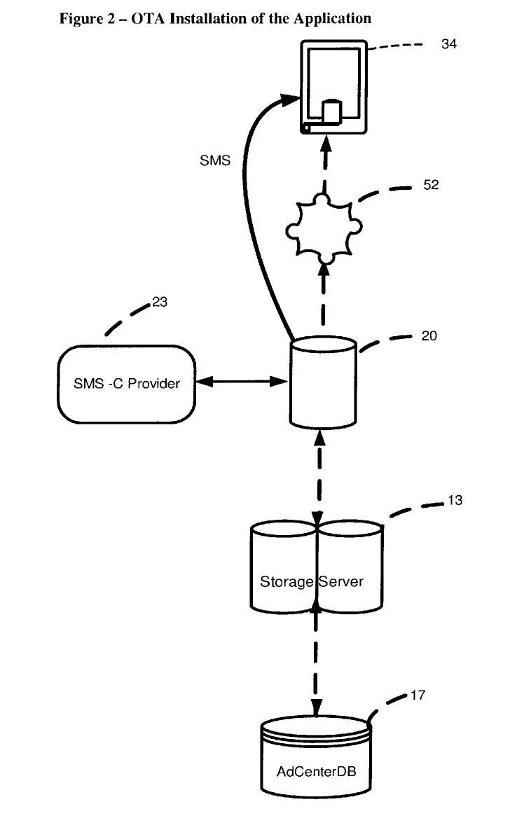

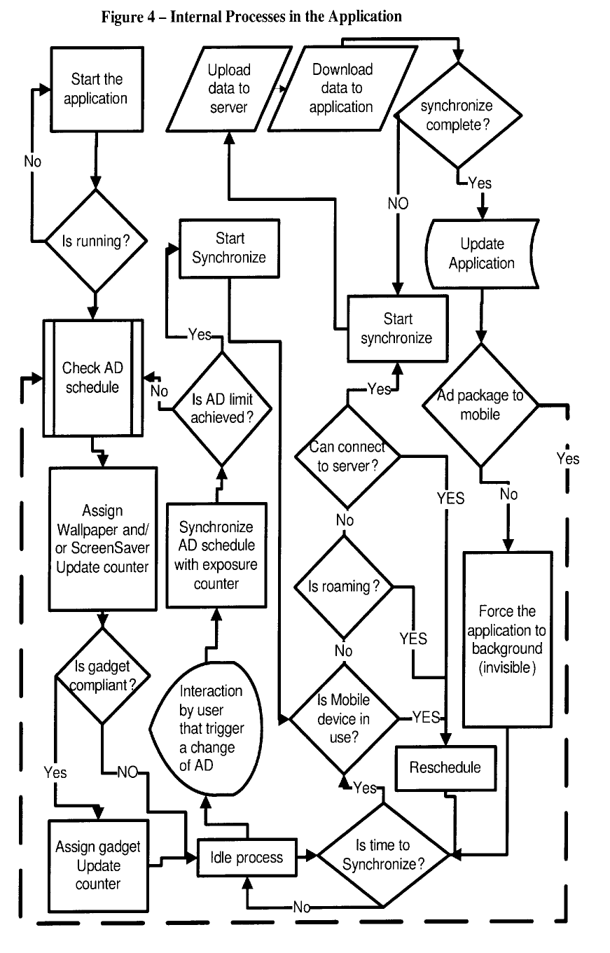

With reference to FIG. 2, there is an overview of the end user downloading the application 52, and the gadget if the MCD 34 is gadget compatible. The end user may request an SMS link by typing in his or her phone number on a web page or sending a short code to a short number. Then, the end user receives an SMS with a URL link, from which the application and the gadget can be downloaded. The mobile server 20 selects a version of the application 52 that is compatible with the specific MCD after running an internal process for device recognition. In one embodiment of the system, content and settings for displaying the content may be stored in the application 52 before it is downloaded by the end user by running parts of the synchronization process described in FIG. 4.

After the download has been completed on the MCD 34 the application 52 starts the installation phase. The application 52 preferably will contain not only the program for handling the advertisement for the wallpaper and/or the screen saver, it will also contain a gadget if the mobile device 34, is gadget compliant. The gadget may be white-labeled meaning that the gadget may change its appearance according to the advertisement shown on the MCD as wallpaper and/or screen saver.

### Client—Server Communication

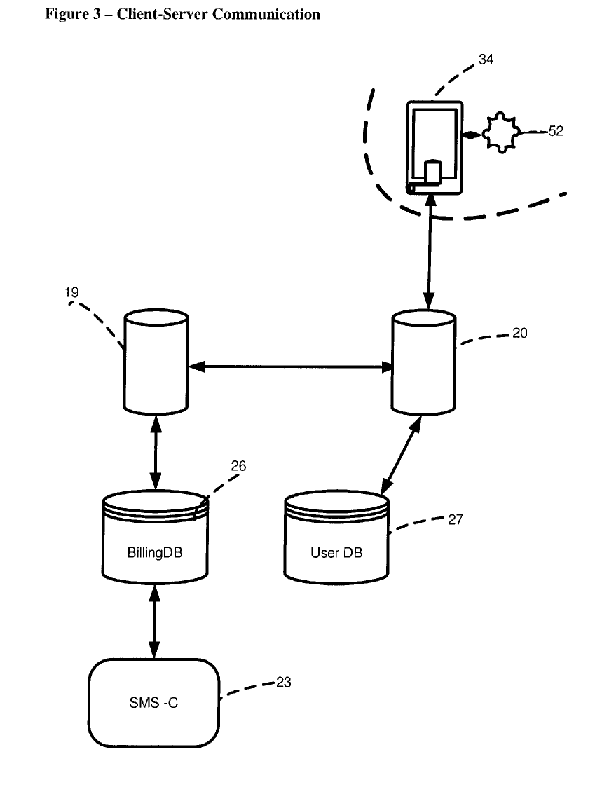

With reference to FIG. 3, there is an overview of the communication between the MCD 34 and mobile server 20 for update and exchanging data. The communication is based on the parameters set within the application 52. The application 52 has a schedule telling the MCD 34 when to connect to the mobile server 20 in order to synchronize. The events affecting the schedule for synchronization may include, but are not limited to, time events (for example, regular and planned updates of content), billing events (for example, exchange of content due to limits on a specific advertiser's budget constraints), location events (for example, restrictions or delays on uploading in order to avoid some or all roaming charges), security events (such as checks that the application is running properly), subscription events (if the user has changed his subscription), agreement events (for example, if the user terminates the agreement).

Preferably, application 52 checks the mode of the MCD 34 before synchronizing. In that case, whether content is received by the MCD 34 or uploaded by the MCD 34 will depend on the mode of the MCD 34. If the MCD 34 is busy or in use, the application 52 may wait until the mobile is in idle mode to connect to the mobile server 20. If the mobile user is outside the subscriber's preferred network and there are roaming charges due to traffic via another carrier, the application preferably will block the synchronization process, terminating any attempt to connect to the mobile server 20 so as to avoid any uncontrolled traffic charge for the user. This may also be achieved by integrating the application 52 with the GPS of the MCD if the MCD has a GPS.

During the synchronization the application 52 may start uploading user data to the mobile server 20. When this process is completed the application 52 may start downloading new content as well as updating the content schedule. When this process is completed the application 52 will terminate the connection to the mobile server 20.

### The MCD Client Application

With reference to FIG. 4, there is a flowchart showing the internal processes and function in the mobile application 52. The application 52 starts up after having been successfully installed on the MCD 34. During the startup process the application 52 will check that the application is running. Next process is checking the ad schedule in order to select the correct ad to display as wallpaper and/or screen saver. The application 52 assigns wallpaper and/or screen saver and increment the counter for the specific content item. The exposure of each ad may be counted since a new ad, according to a pre-defined schedule, is exposed every time the application is activated. If the MCD 34 is gadget compliant and the specific ad permits the application 52 may add a gadget to the gadget graphical user interface (“GUI”). The gadget may change its appearances according to the ad that is displayed as wallpaper and/or screen saver. Otherwise, the ad is passively displayed without a gadget. The application 52 may now go into idle process. If the mobile user interacts with the MCD 34 the application 52 awakes and checks for next ad to be displayed. In other embodiments of the system the application 52 may be programmed to awake due to other trigger events, including but not limited to time events and location events.

The client application 52 may check if the budget constraint of any advertiser has been fulfilled. If all ads have been shown according to the limit set on a specific campaign the application 52 may start synchronizing with the mobile server 20. In order to ensure that the end user is not negatively affected by the synchronization process there are processes checking whether the MCD 34 is in use and whether there is any risk for roaming charges for any data transfer. The check for roaming charges may be performed on the server-side by tracing the signal to the server.

If the application 52 fails to connect due to abovementioned processes or any other reason the application 52 may wait to next scheduled time for synchronization. If the application 52 succeeds to connect to the mobile server 20 it may start uploading usage data, including but not limited to, the number of times each ad has been shown, the time for each exposure and the time length for each exposure.

After the uploading process has been completed the application 52 may start downloading the next ad package and ad schedule. If the transfer succeeds the application 52 may terminate the connection to the mobile server 20. If the application 52, during the synchronization, received instructions to display more ads the check ad schedule process will be initiated.

If the application 52 got instructions that it should not show any ads it may be set to become invisible. This means that the application 52 is forced to the background so that the latest wallpaper and/or screen saver selected by the end user is displayed in the MCD 34 and that the end user has full control to select a new wallpaper and/or screen saver. The application 52 may become visible again after a new synchronization with the mobile server 20 when a new ad package and ad schedule has been received containing instructions to display ads. Thus, when there are no ads to be shown the control over the wallpaper and/or screen saver is transferred to the end user meaning that the end user does not have to give up the control when there are empty slots, for example, if no ads have been sold.

In one embodiment of the system, the end user may be given the option to temporarily inactivate the application 52 in order to be able to control the selection of wallpaper and/or screen saver. This may be achieved by giving the end user a possibility to inactivate and reactivate the application 52 via, for example, a web interface or by sending in a short code to a short number. The reason for such behavior may be that the user, during certain time periods such as vacation, values the selection of wallpaper and/or screen savers more than during other time periods.

### The Gadget

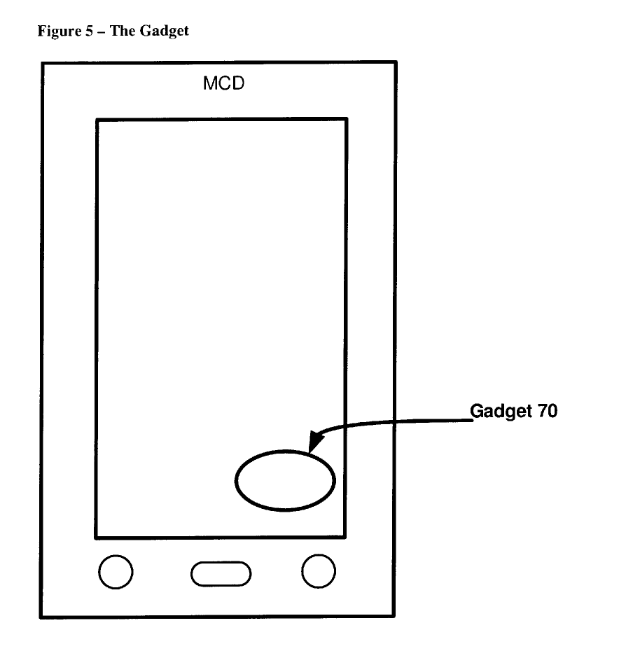

With reference to FIG. 5, there is provided one embodiment of the system that enables the end user to interact with the ad currently displayed as wallpaper by clicking on a gadget. On gadget compatible MCDs a specific gadget 70 may be assigned by the application 52. The gadget 70 may change icon layout based on the advertisement shown in the wallpaper or may be designed as a general clickable button that clarifies that it is connected to the ad, for example, by including the text “see more”. When the end user clicks on the gadget he or she will automatically be directed to a URL that is connected to the ad that was displayed when the gadget was clicked on.

The gadget may always be displayed on the same spot on the screen even if the user scrolls the menu during navigation. If the wallpaper is not active, if there is no advertisement to be displayed by the wallpaper or if the advertisement in the wallpaper does not include any reference to an online site the gadget 70 may be inactivated or hidden. If there are more than one ad displayed in the wallpaper there may be several gadgets, each one displayed in connection to the ad that it is connected to.

In one embodiment of the system other gadgets may be displayed on the screen that may or may not be connected to the wallpaper. All such gadgets may be connected to a specific URL. These gadgets are “white labelled” meaning that each URL at different point in times may be controlled by different advertisers. These gadgets may either have a general design or an adjustable design depending on the ad or offering displayed in the URL.

### Setting Ad Package

With reference to FIG. 6 there is a description of an internal process within the ad center database 17, where an ad selection process may take place. The purpose of this process is to determine which ads shall be exposed in each unique MCD until the next synchronization event. Every MCD has a unique set of parameters, based on the user of the MCD, and every ad has a unique set of parameters as a result of the campaign design process described above. In FIG. 6, MCD 80 is associated with the unique parameters 81 based on its user's sex, location, age and hobby. Likewise, ad is associated with unique parameters 83, that an advertiser associates with its target audience. These parameters may be used during the matching process according to FIG. 6. The parameters that the matching process is based on may be, but are not limited to:

The user's age

The user's gender

The user's address (zip code)

Other user demographics such as hobbies

The number of parameters that need to match for an ad to be included in the ad package may vary, but are to be defined before a campaign is sold. For example, for some parameters 81, 83, there may need to be a full match in order to expose a specific ad 84 in a specific MCD 80. Other parameters may be used in order to optimize the ROI on a campaign with regards to factors such as reaching as many unique users as possible, targeting criteria and price per exposure. The result of the process is an ad package 85, containing all ads that are to be displayed during the time period until a new synchronization takes place.

### Ad Schedule Setting

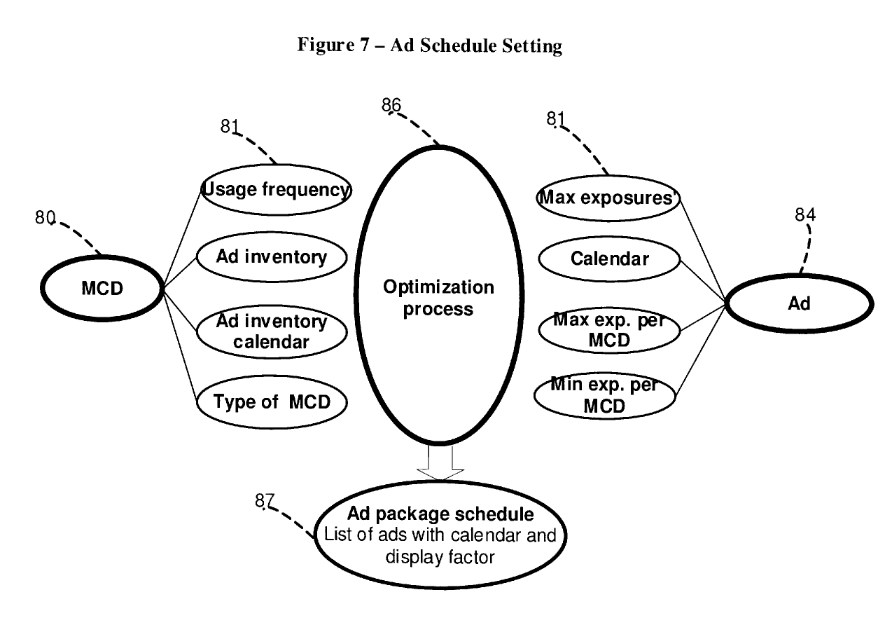

With reference to FIG. 7 there is a description of an optimization process for setting a schedule for the displaying of ads in the ad package. The optimization process may be based on parameters 81, including but not limited to:
Usage frequency (historical usage frequency related to the MCD 80, which may for example be expressed as the number of exposures during per time unit and/or time length of each exposure)
Ad inventory (the total number of unexposed ads for a specific MCD)
Ad inventory calendar (the time period when each ad included in the ad inventory is to be displayed)
Total number of ads in the ad package
The type of slot for the ad (wallpaper, screen saver or gadget)
The maximum number of exposures for each ad according to budget restrictions (preferably set or agreed to by the advertiser)
The minimum number of unique that an ad should be exposed for (preferably set or agreed to by the advertiser)
The minimum number of exposures for an ad (preferably set or agreed to by the advertiser)
The maximum number of exposures for an ad (preferably set or agreed to by the advertiser)
Time criterion—certain points in time during which an ad should be displayed (preferably set or agreed to by the advertiser)
The type of MCD
Location criterion—location events that should trigger the exposure of an ad

The optimization process 86, may assign a calendar and a display factor for each ad 84 in the ad package, producing ad package schedule 87. The purpose of the calendar is to enable advertisers to set a specific time period for a campaign. However, since the total number of exposures per time unit varies between MCDs 80, due to different usage frequency, and since the ad inventory (the total number of exposures that are waiting to take place as a result of sold but uncompleted campaigns) will be different between MCDs 80, due to targeting requests from advertisers, different schedules need to be set for each MCD 80. This is achieved by assigning a display factor for each advertisement determining the relative frequency for the display of each ad in the ad package. For example, if one ad is to be displayed twice the number of times as the average ad in the ad package it is assigned a display factor of 2.

The logical structure for setting the ad package schedule 87 may vary between MCDs 80 dependent on, for example, characteristics of the devices and their users. In some devices several different ads can be shown at the same time, for example, depending on the screen size of the MCD 80, and user demographics such as age. The logical structure for setting the ad schedule may also vary depending on how and when the wallpaper and/or screen savers are exposed in the specific MCD 80. In some MCDs 80, the wallpaper is displayed before it is locked up, in some MCDs 80, the wallpaper is displayed after the device has been locked up but before the user has started to navigate and in some MCDs 80, the wallpaper is displayed in the background during navigation. For example, in the latter case the ad setting may be to display a specific ad during a certain time period instead of exchanging ad only when the wallpaper comes in focus. For MCDs 80 including a GPS or other technical support for determining the position of the MCD the ad setting may also be dependent on the location of the end user.

After the ad package setting process and the ad schedule setting process, the ad package will be sent to the mobile server 20 and then synchronized with the application 52.

### Billing Reports

There is an embodiment of the system that handles billing reports. The mobile server 20 may start an internal process with regards to the uploaded content from the client application 52. The mobile server 20 updates the user database 27 with data from the application 52 and sends over relevant billing data to the billing server 19. The billing server will process the information received from the mobile server 20 and update the billing database 26 with the relevant data to be used in order to compensate the end user according to terms and conditions that have been agreed on. Such data could be, but is not limited to, the number of times that ads have been displayed in the wallpaper and/or screen saver, the time length of the display of ads, the number of clicks on the gadget, the number of times and time length the application or gadget has been uninstalled or overridden and the amount of other gadgets or applications hiding the content displayed by the application.

Billing data is also processed as a basis for billing reports and invoices to advertisers. All kinds of data that affect the pricing are processed based on the parameters set in the payment model with the advertiser.

### Security

Since the end users may be rewarded in monetary terms for opting in to the system and thereby accepting the displaying of ads as wallpaper, screen saver and/or gadgets in the MCD and since advertisers are paying for the displaying of ads, it ordinarily is of utmost importance to ensure that the ads really are displayed. If the application in the MCD would be inactivated or uninstalled the synchronization process would not take place according to the pre-defined schedule. Failure to synchronize can therefore be used to trigger a security process. However, the synchronization process could fail to take place due to several other reasons as well, for example, if the user is interacting with the MCD, if the user is travelling and synchronization is deactivated to avoid roaming charges, or if the MCD is turned off. Therefore, there may be a logical structure for handling such scenarios. For example, if the application has been unable to connect to the mobile server for a certain time period the mobile server may inform the billing server. In one embodiment of the system a message, for example an SMS, may be sent to the end user either at the MCD or at another location associated with the end user, with information about the technical status and/or a question about circumstances that could explain the situation. The end user may be asked to respond to the message if he or she still wants to be connected to the service.

Since the ad runs in the background there might be other functions that display content in front of the wallpaper, for example gadgets. In one embodiment of the system it may be possible for the application in the MCD to collect information about the exposure of the advertisement, the extent to which it has been obscured by other material displayed on the MCD, and the nature of the material that has obscured the display. When the application synchronizes with the mobile server it may upload information about such events. Such information may, in turn, be transferred to the billing server and affect the rewards to end users and the invoices to advertisers.

### Monetary Rewards to End-Users

The disclosed invention allows the end users to be rewarded in monetary terms. An example of how this could be executed is by reducing their costs of mobile communication. Users with postpaid subscription models may be automatically discounted on their monthly bill and users with prepaid subscription models may instead be compensated by automatically loading their prepaid card. The compensation may be a fixed amount or a variable amount depending on the amount of advertisements that have been exposed or a combination thereof. In one example, the user is guaranteed a fixed compensation levels subject to various parameters connected to the exposure of content presented in the billing reports.

The discount may also be incorporated in the subscription model or pricing strategy of the mobile carrier. For instance, the end user could get a discount when purchasing the MCD or discounted prices for voice calls or data transfer.

1. A method for advertising in a mobile communication device, comprising:
(a) communicating with at least one mobile communication device over a communication network, the mobile communication device having a standard graphical user interface framework for displaying passively displayed content and at least one level of display;
(b) transmitting data between at least one mobile server and the mobile communication device over the communication network under predetermined conditions;
(c) transferring control of selection of passively displayed content on the lowest level display of the graphical user interface of the mobile communication device to at least one third party based upon the data transferred;
(d) transmitting content for passive display on the lowest level display of the graphical user interface from the third party;
(e) displaying the content received from the third party on the lowest level display of the graphical user interface, without user action, under predetermined conditions;
(f) transmitting a signal to at least one billing server, the signal providing information regarding usage of the content received from the third party, the at least one billing server adapted to compensate the user at a predetermined rate if the content received from the third party has been displayed.

2. The method of claim 1, wherein the third party is at least one of a phone network operator, advertiser, or advertising reseller.

3. The method of claim 1, further comprising providing an interactive user interface via a gadget on the displayed content, the interface adapted to redirect the user to additional content provided by the third party.

4. The method of claim 1, further comprising pre-checking the mode of the mobile communication device based on predetermined criterion before receiving content for passive display from the third party or uploading data to the mobile server.

5. The method of claim 4, further comprising blocking the receipt of content for passive display from the third party or the upload of data to the mobile server, if this would lead to roaming charges.

6. The method of claim 1, wherein the predetermined conditions include at least one of the mode of the mobile communication device, the user's demographics, user preference, time events, billing events, location events, security events, subscription events and agreement events.

7. The method of claim 1, further comprising automatically optimizing the content received from the third party for the mobile communication device.

8. The method of claim 1, wherein the mobile server transmits relevant billing data to a billing server for processing.

9. A system for advertising on a mobile communication device comprising:
(a) A mobile server in communication with a mobile communication device, the mobile server controlling interaction between passively displayed content on a graphical user interface of the mobile communication device, and the user; the mobile server being further adapted for
i. communicating with at least one mobile communication device over a communication network using the mobile communication device's standard graphical user interface structure;
ii. transmitting data between the mobile server and the mobile communication device over the communication network under predetermined conditions;
iii. transferring control of selection of passively displayed content on the lowest level display of the graphical user interface of the mobile communication device to at least one third party based upon the data transferred;
iv. receiving content for passive display on the lowest level display of the graphical user interface from the third party;
v. displaying the content received from the third party on the lowest level display of the mobile communication device, without user action, under predetermined conditions;
vi. transmitting a signal to the mobile server, the signal providing information regarding usage of the content received from the third party; and
vii. communicating with at least one billing server adapted to compensate the user at a predetermined rate if the third party content has been displayed;
(b) at least one billing server in communication with at least the mobile server, the billing server adapted to automatically compensate a user at a predetermined rate if the third party content has been displayed, or upon user interaction with passively displayed content; and
(c) at least one storage server in communication with at least one server selected from the group including the mobile server, the web server, and the billing server;
(d) a communication network adapted to allow the exchange of data between the mobile communication device and at least one of the mobile server, web server, billing server and the storage server; and
(c) an application coupled to the existing graphical user interface structure of the mobile communication device, the application being adapted to:
i. receive content for passive display from the third party;
ii. display the content received from the third party on the mobile communication devices' graphical user interface; and
iii. transmit a signal to the mobile server, the signal providing information regarding usage of the content received from the third party.

10. The system of claim 9, wherein the billing server is adapted to process the billing data based on at least one of payment model agreements with advertisers, agreements with end users.

11. The system of claim 9, wherein the application comprises at least one gadget which is displayed in the forefront of the mobile communication devices' graphical user interface.

12. The system of claim 11, wherein the gadget is adapted to allow the user to engage with the advertisement by clicking on the gadget.

13. The system of claim 9, wherein the billing server is adapted to credit a user's account by integrations with the billing system of at least one of network carriers, billing providers, or combinations thereof.

14. The system of claim 13, wherein the credit is one of a reduction in a post-paid subscription or a credit to a pre-paid card or a payment to a user's bank account or towards a user's payment card or credit card.

15. The system of claim 9, wherein the predetermined rate is based upon at least one of number of impressions (cost per mille), number of clicks, certain user action, or combinations thereof.

16. The system of claim 9, wherein the mobile server is adapted to connect to the mobile communication device only when it is not in a roaming mode.

17. The system of claim 9, wherein the application is integrated with a global positioning system.

18. The system of claim 9, wherein the mobile server is adapted to pre-check the mode of the mobile communication device before transmitting displayed content.

19. The system of claim 9, wherein the mobile server is adapted to select content for display based on at least one of location criterion, time criterion, exposure limit criterion, type of slot, total number of advertisements in the campaign, inventory, usage frequency or a combination thereof.

20. The system of claim 9, wherein the displayed content comprises a gadget that automatically directs a user who clicks the gadget to a URL that is associated to an ad that was displayed in the gadget or in the lowest level of the graphical interface when the gadget was clicked on.

21. A computer readable medium storing a sequence of instructions, which when executed by the graphical user interface structure of a mobile communication device, causes the graphical user interface structure of the mobile communication device to perform the following steps:
(a) receiving advertising information from a mobile server in communication with a web server accessible by an advertiser, the mobile server being adapted to select the transmittal criteria and content of the advertising information prior to transmittal, the web server comprising advertising data input by a third party;
(b) displaying the advertising information on the lowest level of display of the graphical user interface in accordance with the instructions received; and
(c) exchanging requested information with the mobile server for transmission to at least one billing server, the billing server in communication with at least one financial institution and adapted to automatically compensate a user of the mobile communication device upon display of the advertising information on the graphical user interface.
